(19) United States
(12) Patent Application Publication
(10) Pub. No.: US 2009/0198901 A1
(43) Pub. Date: Aug. 6, 2009

(54) COMPUTER SYSTEM AND METHOD FOR CONTROLLING THE SAME

(76) Inventor: Yoshihiro Koga, Osaka (JP)

Correspondence Address: MCDERMOTT WILL & EMERY LLP, 600 13TH STREET, NW, WASHINGTON, DC, 20005-3096, US

(21) Appl. No.: 12/247,670

(22) Filed: Oct. 8, 2008

(30) Foreign Application Priority Data
Jan. 31, 2008 (JP) 2008-021863

(51) Int. Cl. G06F 12/08

(52) U.S. Cl. 711/129; 711/136; 711/133; 711/E12.022; 711/E12.042

(57) ABSTRACT

A computer system includes a main memory for storing a large amount of data, a cache memory that can be accessed at a higher speed than the main memory, a memory replacement controller for controlling the replacement of data between the main memory and the cache memory, and a memory controller capable of allocating one or more divided portions of the cache memory to each process unit. The memory replacement controller stores priority information for each process unit, and replaces lines of the cache memory based on a replacement algorithm taking the priority information into consideration, wherein the divided portions of the cache memory are allocated so that the storage area is partially shared between process units, after which the allocated amounts of cache memory are changed automatically.

### BACKGROUND OF THE INVENTION

1. Field of the Invention

The present invention relates to a computer system with an improved efficiency of use of a cache memory, and a method for controlling the same.

2. Description of the Background Art

In a conventional computer system, the number of functions (processes therefor) has been increasing, and a mechanism has been proposed in the art (see, for example, Japanese Laid-Open Patent Publication No. 9-146842 and United States Patent Application Publication No. 2007/0033341) in which the storage area of the cache memory, which influences the processing performance, is divided into portions, each corresponding to one process unit so as to avoid as much as possible the interference between processes.

As a countermeasure against the decrease in the efficiency of use of the cache memory after being divided into portions, a technique has been proposed in the art (see, for example, U.S. Pat. No. 7,293,144) in which the cache memory is re-allocated each time a process is started according to information on the priority of processes.

### SUMMARY OF THE INVENTION

In a conventional computer system, however, when a process unit joins or leaves the group of process units running at the same time, it is necessary to re-set the amount of allocated cache memory for all process units, and it is necessary to provide means for calculating the amounts to be re-set. This complicates the system, and invites the problem of interference between process units.

It is therefore an object of the present invention to realize a computer system capable of accommodating a change to the group of process units running at the same time without having to re-set the amount allocated cache memory.

In order to achieve the object set forth above, the present invention provides a computer system, including: a plurality of process units; a main memory for storing data to be used by the plurality of process units; a cache memory that can be accessed at a higher speed than the main memory; a memory controller for allocating divided portions of a storage area of the cache memory to the plurality of process units, wherein when one of the plurality of process units terminates, the memory controller releases a portion of the entire storage area of the cache memory, which has been used by the terminating process unit, so that the released portion is available to another process unit; and a memory replacement controller storing information on an order of priority between the plurality of process units for controlling replacement of data between the main memory and the cache memory based on a cache memory replacement algorithm taking the priority information into consideration, wherein: the plurality of process units include a basic process unit for realizing a basic function of a device which uses the computer system; and the memory controller determines allocation of the cache memory in advance so that a portion of the storage area of the cache memory is dedicated to the basic process unit and at least another portion of the storage area of the cache memory is used preferentially by process units other than the basic process unit over the basic process unit.

With the computer system of the present invention, the amount of cache memory allocated for each process unit can be varied automatically without re-setting. Therefore, even when a process unit joins or leaves the group of process units running at the same time, it is not necessary to re-set the amount of allocated cache memory for all process units, and it is also not necessary to provide means for calculating the amounts to be re-set, whereby it is possible to change the amounts of allocated cache memory without complicating the system or creating interference between process units.

### BRIEF DESCRIPTION OF THE DRAWINGS

FIG. 1 is a block diagram showing an example of a configuration of a computer system according to the present invention.

FIG. 2 is a conceptual diagram showing an example of an internal configuration of a cache memory of FIG. 1.

FIG. 3 is a conceptual diagram illustrating the replacement priority in the cache memory of FIG. 2.

FIG. 4 is a timing diagram showing an example of the operation sequence of the three process units of FIG. 1.

FIG. 5 is a conceptual diagram showing an internal state of the cache memory of FIG. 2 at Time T1 in FIG. 4.

FIG. 6 is a conceptual diagram showing an internal state of the cache memory of FIG. 2 at Time T2 in FIG. 4.

FIG. 7 is a conceptual diagram showing an internal state of the cache memory of FIG. 2 at Time T3 in FIG. 4.

FIG. 8 is a flow chart showing an example of a release function of a memory controller of FIG. 1.

FIG. 9 is a flow chart showing another example of a release function of the memory controller of FIG. 1.

FIG. 10 is a flow chart showing still another example of a release function of the memory controller of FIG. 1.

FIG. 11 is a flow chart showing still another example of a release function of the memory controller of FIG. 1.

FIG. 12 is a conceptual diagram showing another example of an internal configuration of the cache memory of FIG. 1.

FIG. 13 is a conceptual diagram illustrating the replacement priority in the cache memory of FIG. 12.

FIG. 14 is a conceptual diagram showing an internal state of the cache memory of FIG. 12 at Time T1 in FIG. 4.

FIG. 15 is a conceptual diagram showing an internal state of the cache memory of FIG. 12 at Time T2 in FIG. 4.

FIG. 16 is a conceptual diagram showing an internal state of the cache memory of FIG. 12 at Time T3 in FIG. 4.

### DETAILED DESCRIPTION OF THE INVENTION

An embodiment of a computer system of the present invention will now be described with reference to the drawings.

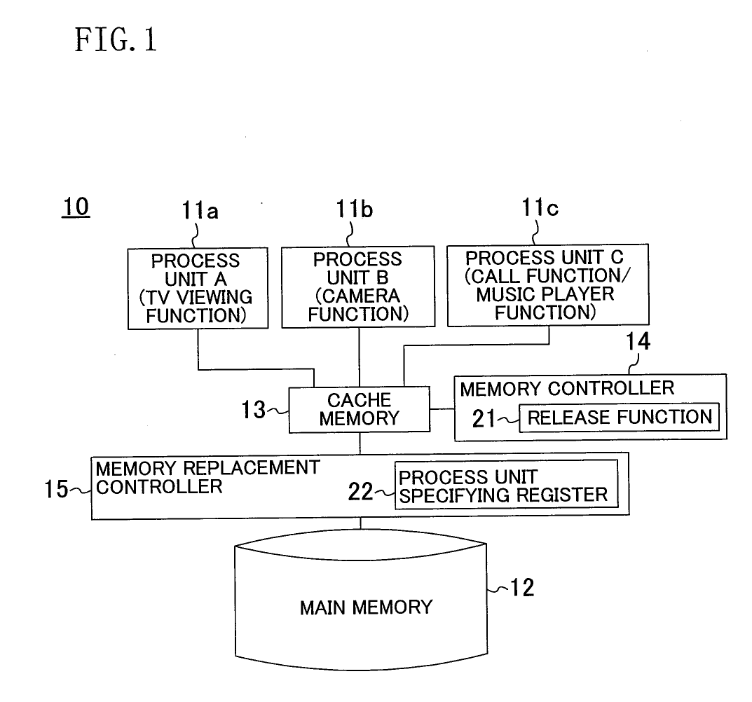

FIG. 1 shows an example of a configuration of a computer system according to the present invention. A computer system 10 of FIG. 1 includes a first process unit (Process unit A) 11a, a second process unit (Process unit B) 11b, a third process unit (Process unit C) 11c, a main memory 12, a cache memory 13, a memory controller 14, and a memory replacement controller 15.

The first, second and third process units 11a, 11b and 11c may each be hardware (a dedicated circuit) such as a processor or software such as a thread or a program. Normally, software is stored in a storage medium such as a ROM. In the present embodiment, it is herein assumed that the first, second and third process units 11a, 11b and 11c are all processors, for the sake of simplicity.

It is herein assumed that the third process unit 11c is a basic process unit for realizing the basic function of the device which uses the computer system 10. For example, where the computer system 10 is used in a portable telephone, the third process unit 11c is responsible for the call function or the music player function, the second process unit 11b for the camera function, and the first process unit 11a for the TV viewing function. The call function herein refers to a general function of making a call with another portable telephone. The music player function refers to a general portable music player function of reproducing a music file compressed in an audio codec format such as MPEG2-AAC, MP3 or ATRAC3. The camera function refers to a picture taking function of a digital still camera, or the like. The TV viewing function refers to a general TV viewing function such as an analog TV viewing function, a one-segment digital TV viewing function or a full-segment digital TV viewing function.

The main memory 12 is a memory for storing data to be used by the first, second and third process units 11a, 11b and 11c. The cache memory 13 is a memory that can be accessed at a higher speed than the main memory 12.

The memory controller 14 allocates divided portions of the storage area of the cache memory 13 to the first, second and third process units 11a, 11b and 11c. The memory controller 14 has a release function 21, whereby when one of the first, second and third process units 11a, 11b and 11c terminates, the memory controller 14 releases the storage area portion of the cache memory 13 being used by the terminating process unit so that the storage area portion can be used by other process units.

The memory replacement controller 15 has information on the order of priority between the first, second and third process units 11a, 11b and 11c, and controls the replacement of data between the main memory 12 and the cache memory 13 based on a cache memory replacement algorithm taking the priority information into consideration. The memory replacement controller 15 includes a process unit specifying register 22, being a register for specifying one of the first, second and third process units 11a, 11b and 11c as being the basic process unit. In the above portable telephone example, the process unit number (e.g., 0xc; “0x” being the hexadecimal prefix) of the third process unit 11c responsible for the call function or the music player function is set in the process unit specifying register 22.

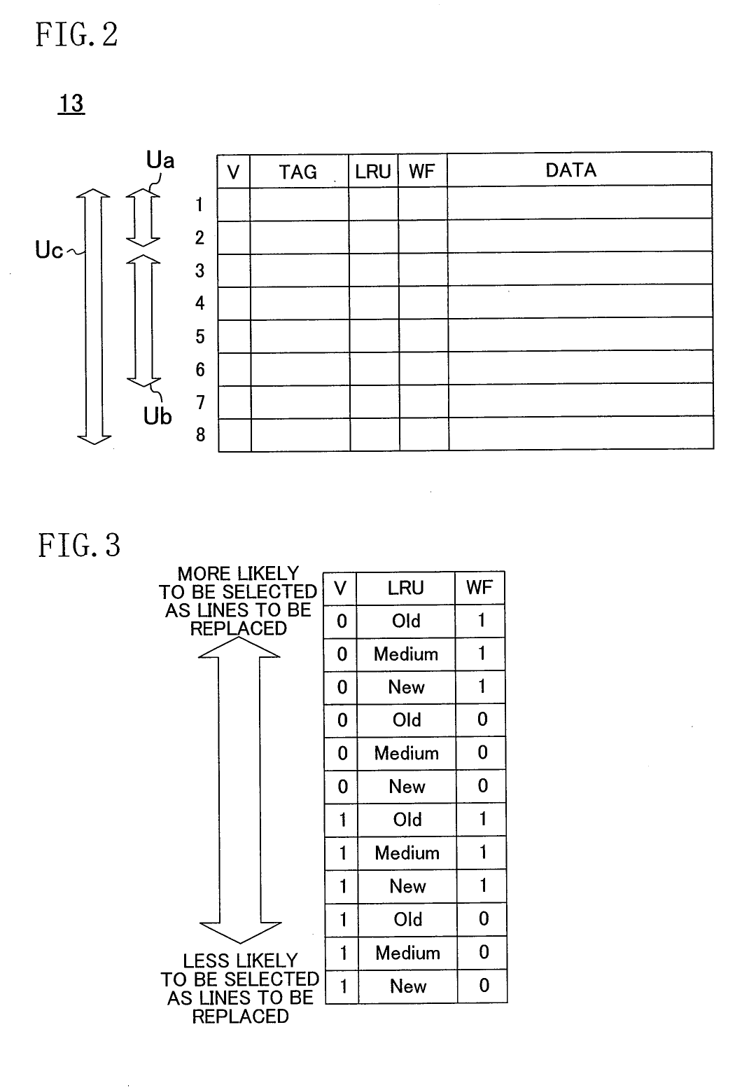

FIG. 2 shows an example of an internal configuration of the cache memory 13 of FIG. 1. The cache memory 13 of FIG. 2 includes a storage area of eight cache memory lines (Lines 1 to 8). Each cache memory line is a unit by which the cache memory 13 is used, and includes cached data (DATA), a weak flag (WF) indicating whether the cache memory line is to be preferentially replaced, memory replacement determination information (LRU: Least Recently Used) representing the priority for replacement based on a common LRU algorithm, a tag (TAG) for identifying the address in the main memory 12, and a validity bit (V) indicating whether the data stored in the cache memory line is valid.

In FIG. 2, Ua, Ub and Uc denote the cache memory lines allocated to the first, second and third process units 11a, 11b and 11c, respectively. For example, the memory controller 14 allocates Lines 1 and 2 to the first process unit 11a, Lines 3 to 6 to the second process unit 11b, and Lines 1 to 8 to the third process unit 11c. The memory controller 14 determines the allocation of the cache memory 13 in advance so that Lines 7 and 8 are dedicated to the third process unit 11c, Lines 1 and 2 are used preferentially by the first process unit 11a over the third process unit 11c, and Lines 3 to 6 are used preferentially by the second process unit 11b over the third process unit 11c.

When data is transferred from the main memory 12 to a line of the cache memory 13 in response to a request from the third process unit 11c being the basic process unit, for example, the memory replacement controller 15 sets the weak flag (WF) to “1”, meaning that the line is likely to be replaced, and thereafter uses a cache memory replacement algorithm by which lines with the weak flag (WF) being “1” are preferentially selected, in addition to the LRU algorithm above.

FIG. 3 is a conceptual diagram illustrating the replacement priority in the cache memory 13 of FIG. 2. Cache memory lines closer to the top in FIG. 3 are more likely to be replaced, and vice versa. More specifically, lines with the validity bit (V) being “0” (invalid) are more likely to be selected as lines to be replaced than those with the validity bit (V) being “1” (valid). With the validity bit (V) being equal, lines with the weak flag (WF) being “1” are more likely to be selected as lines to be replaced than those with the weak flag (WF) being “0”. With the validity bit (V) and the weak flag (WF) both being equal, lines to be replaced are determined based on the well-known LRU algorithm. In FIG. 3, LRU values of “old”, “medium” and “new” are used, wherein “old” lines are most likely to be replaced and “new” lines are least likely to be replaced. A random method or any other suitable priority determining algorithm may be used, instead of the memory replacement determination information LRU.

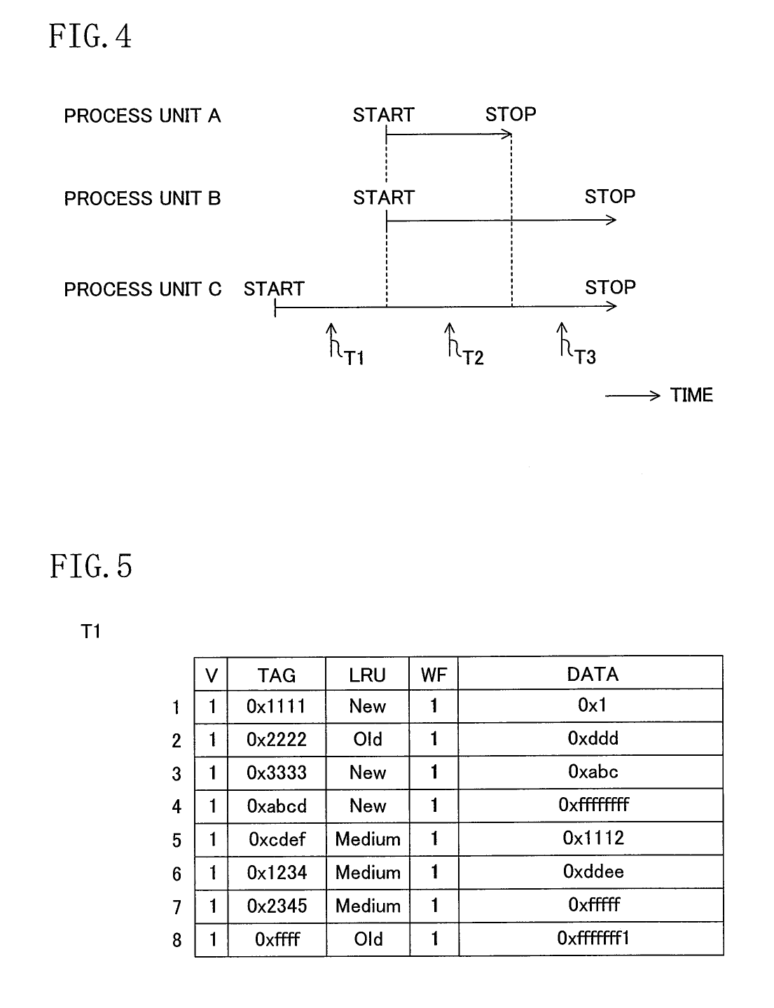

FIG. 4 shows an example of an operation sequence of the first, second and third process units 11a, 11b and 11c of FIG. 1. In the illustrated example, the third process unit (Process unit C) 11c first starts. Then, the first and second process units (Process units A and B) 11a and 11b start at the same time, and the first process unit (Process unit A) 11a thereafter terminates. Thus, referring to FIG. 4, only the third process unit 11c is running at Time T1, the first, second and third process units 11a, 11b and 11c are all running at Time T2, and the second and third process units 11b and 11c are running at Time T3.

FIGS. 5, 6 and 7 show the internal state of the cache memory 13 of FIG. 2 at Time T1, Time T2 and Time T3 in FIG. 4, respectively.

Referring to FIG. 5, the weak flag (WF) is set for all the cache memory lines after the third process unit 11c runs for a certain amount of time. If, for example, a replacement of a cache memory line occurs in response to a request from the third process unit 11c in this state, Lines 2 and 8 are selected as first candidates to be replaced based on the order of priority shown in FIG. 3. One of these candidates is selected and replaced by the memory replacement controller 15 (the method of selection among candidates with the same level of priority depends on how the system is implemented in practice, and will not be discussed herein as it is not directly related to the present invention). Since the third process unit 11c is a process unit that is specified by the process unit specifying register 22 and is the basic process unit of which the weak flag (WF) is set to “1”, the memory replacement controller 15 sets the weak flag (WF) to “1” for the associated lines even after the replacement.

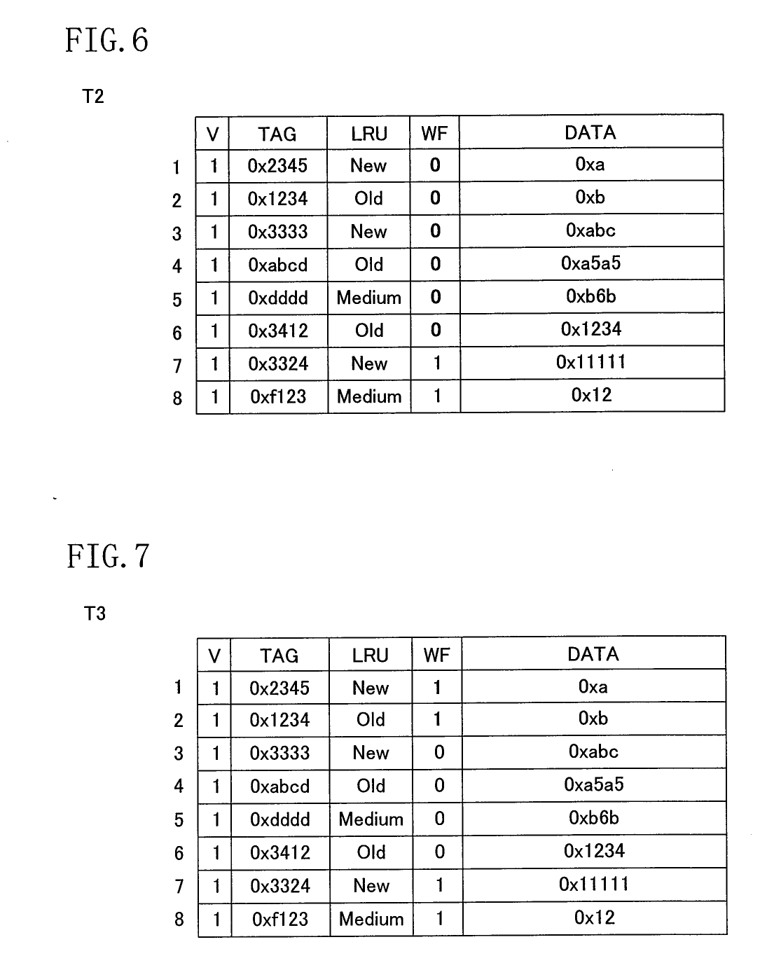

Referring to FIG. 6, the weak flag (WF) is “1” for Lines 7 and 8 that are allocated only to the third process unit 11c after the first, second and third process units 11a, 11b and 11c run for a certain amount of time. Lines 1 and 2 store data of the first process unit 11a, and the weak flag (WF) is “0” for these lines. Similarly, Lines 3 to 6 store data of the second process unit lib, and the weak flag (WF) is “0” for these lines. If, for example, a replacement of a cache memory line occurs in response to a request from the third process unit 11c in this state, Line 8 is selected as a first candidate to be replaced based on the order of priority shown in FIG. 3. Then, Line 8 is replaced by the memory replacement controller 15. Since the third process unit 11c is a process unit that is specified by the process unit specifying register 22 and is the basic process unit of which the weak flag (WF) is set to “1”, the memory replacement controller 15 sets the weak flag (WF) to “1” for Line 8 even after the replacement.

Referring to FIG. 7, in response to the termination of the first process unit 11a, the weak flag (WF) is set to “1” for Lines 1 and 2 by the release function 21 of the memory controller 14. Herein, the release function 21 is realized by setting the weak flag (WF) to “1” for all of the cache memory lines allocated to the first process unit 11a. As a result, Lines 1 and 2, which have been allocated to the first process unit 11a, become available to another process unit (the third process unit 11c in the illustrated example). If, for example, a replacement of a cache memory line occurs in response to a request from the third process unit 11c in this state, Line 2 is selected as a first candidate to be replaced based on the order of priority shown in FIG. 3. Then, Line 2 is replaced by the memory replacement controller 15. Since the third process unit 11c is a process unit that is specified by the process unit specifying register 22 and is the basic process unit of which the weak flag (WF) is set to “1”, the memory replacement controller 15 sets the weak flag (WF) to “1” for Line 2 even after the replacement.

As described above, with the computer system 10 of FIG. 1, even when a process unit joins or leaves the group of process units running at the same time, it is not necessary to re-set the amount of allocated cache memory for all process units, and it is also not necessary to provide means for calculating the amounts to be re-set, whereby it is possible to change the amounts of allocated cache memory without complicating the system or creating interference between process units. Moreover, by always reserving Lines 7 and 8 for the third process unit 11c being the basic process unit, it is possible to ensure a minimum level of processing performance for the basic process unit irrespective of the process units running at the same time.

Along the lines of portable telephone application, when the first and second process units 11a and 11b are not running, the third process unit 11c responsible for the call function or the music player function can use all the cache memory lines (Lines 1 to 8), as shown in FIG. 5. This means that the amount of the cache memory 13 that can be used by the third process unit 11c for the call function or the music player function is increased, thus reducing the cache miss rate and allowing for an efficient execution of the intended process. When the third process unit 11c is running alone, the process efficiency is improved with a reduced frequency of access to the main memory 12. With these advantageous effects, it is expected that the amount of hardware to be active (running) in the entire computer system 10 is reduced on average, thereby reducing the power consumption.

With the computer system 10 of FIG. 1, the function of automatically changing the amount of the cache memory 13 allocated can be realized with the first process unit 11a or the second process unit 11b, by changing the value of the process unit specifying register 22.

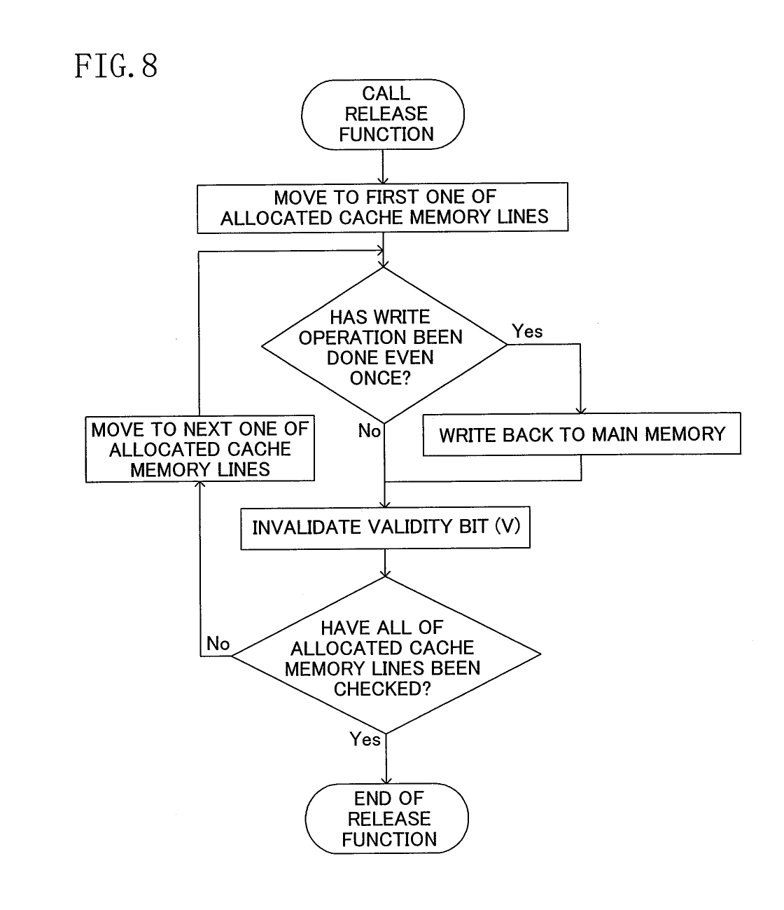

FIGS. 8, 9, 10 and 11 are flow charts each showing an example of how the release function 21 of the memory controller 14 of FIG. 1 is implemented.

Referring to FIG. 8, for each line of the allocated portion of the cache memory 13, data of the line is written back to the main memory 12 and the validity bit (V) is reset to “0” (invalid) for the line, thereby realizing the release function 21 for all the allocated cache memory lines. Thus, each cache memory line, which has been used by a process unit, can be released so that it is available to another process unit, while maintaining the data coherency.

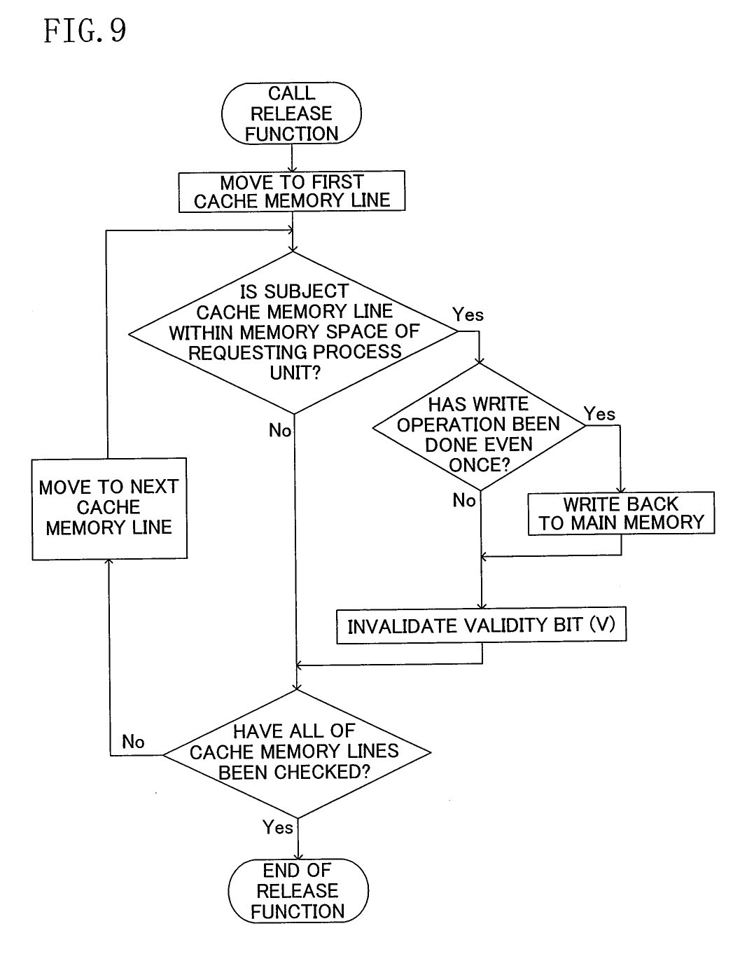

Referring to FIG. 9, a procedure as shown in FIG. 8 is used, except that only those lines that are within the memory space being used by the terminating process unit are subjected to the procedure, thereby realizing the release function 21. Thus, each cache memory line, which has been used by a process unit, can be released so that it is available to another process unit, while maintaining the data coherency, even if the cache memory lines to be released overlap those allocated to another process unit (e.g., a case where the cache memory is a shared memory).

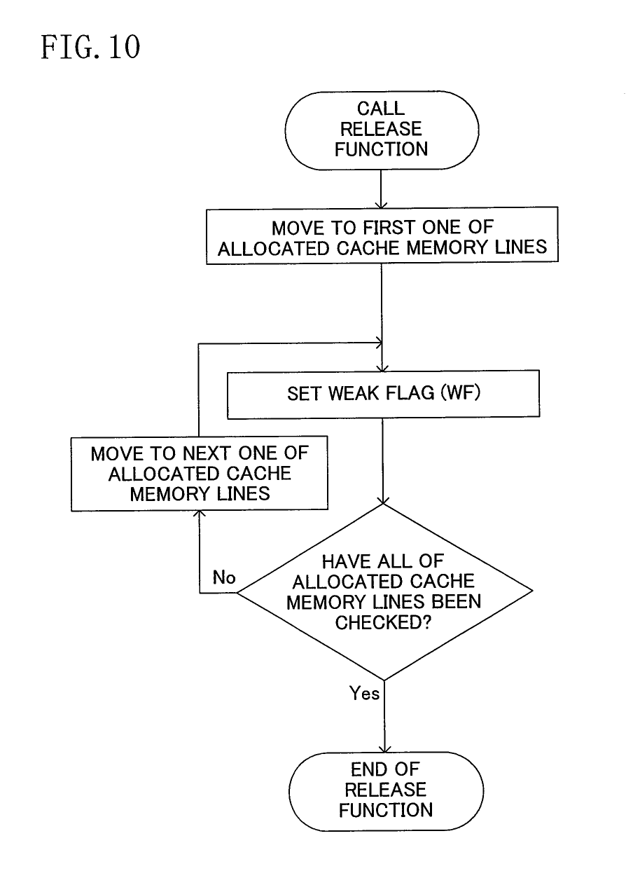

Referring to FIG. 10, for each line of the allocated portion of the cache memory 13, the weak flag (WF) is set to “1”, thereby realizing the release function 21 for all the allocated cache memory lines. Thus, each cache memory line, which has been used by a process unit, can be released so that it is available to another process unit, while maintaining the data coherency, and without generating a local load on the memory bus due to the write back operation.

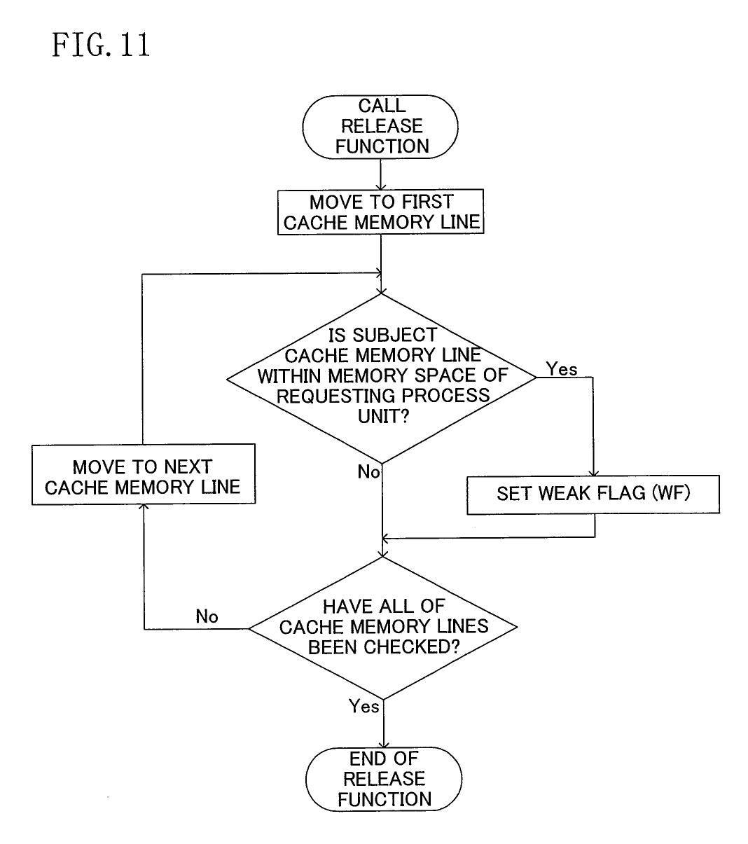

Referring to FIG. 11, a procedure as shown in FIG. 10 is used, except that only those lines that are within the memory space being used by the terminating process unit are subjected to the procedure, thereby realizing the release function 21. Thus, each cache memory line, which has been used by a process unit, can be released so that it is available to another process unit, while maintaining the data coherency, without generating a local load on the memory bus due to the write back operation, even if the cache memory lines to be released overlap those allocated to another process unit (e.g., a case where the cache memory is a shared memory).

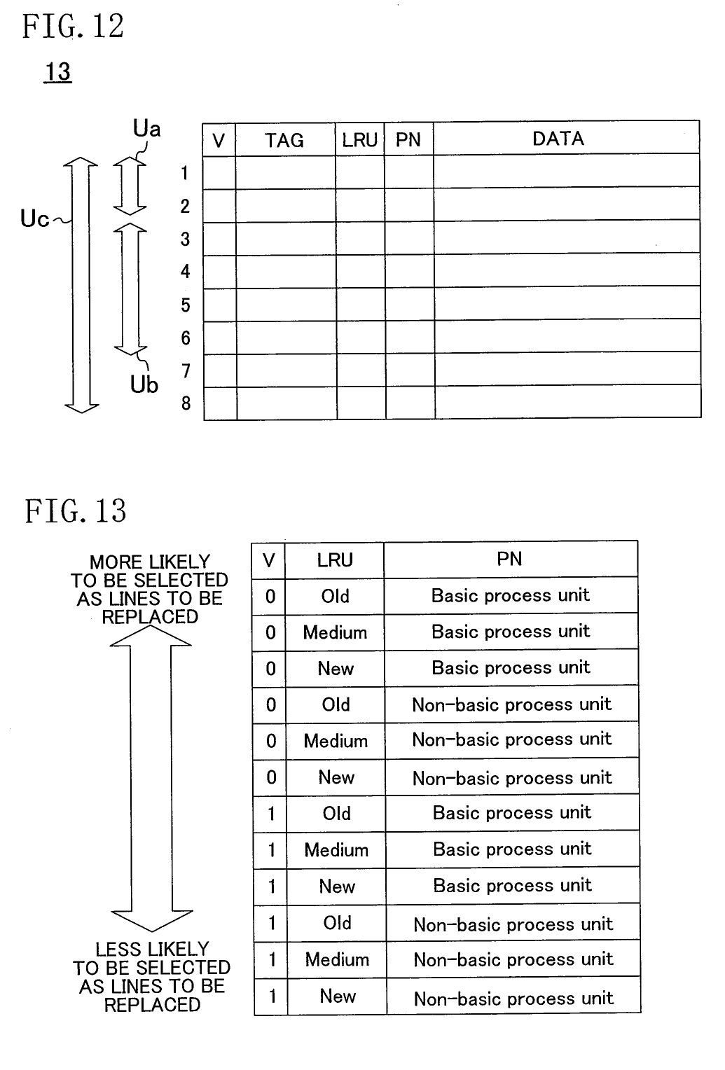

FIG. 12 shows another example of an internal configuration of the cache memory 13 of FIG. 1. Each of the eight cache memory lines has a process unit number (PN), instead of the weak flag (WF) as shown in FIG. 2.

FIG. 13 is a conceptual diagram illustrating the replacement priority in the cache memory of FIG. 12. When data is transferred from the main memory 12 to a line of the cache memory 13 in response to a request from one of the first, second and third process units 11a, 11b and 11c, the memory replacement controller 15 assigns the line a process unit number (PN) that identifies the requesting process unit, and thereafter uses a cache memory replacement algorithm by which lines that are assigned a process unit number (PN) coinciding with the number of the basic process unit specified by the process unit specifying register 22 (e.g., “0xc” representing the third process unit 11c) are preferentially selected, in addition to the LRU algorithm above.

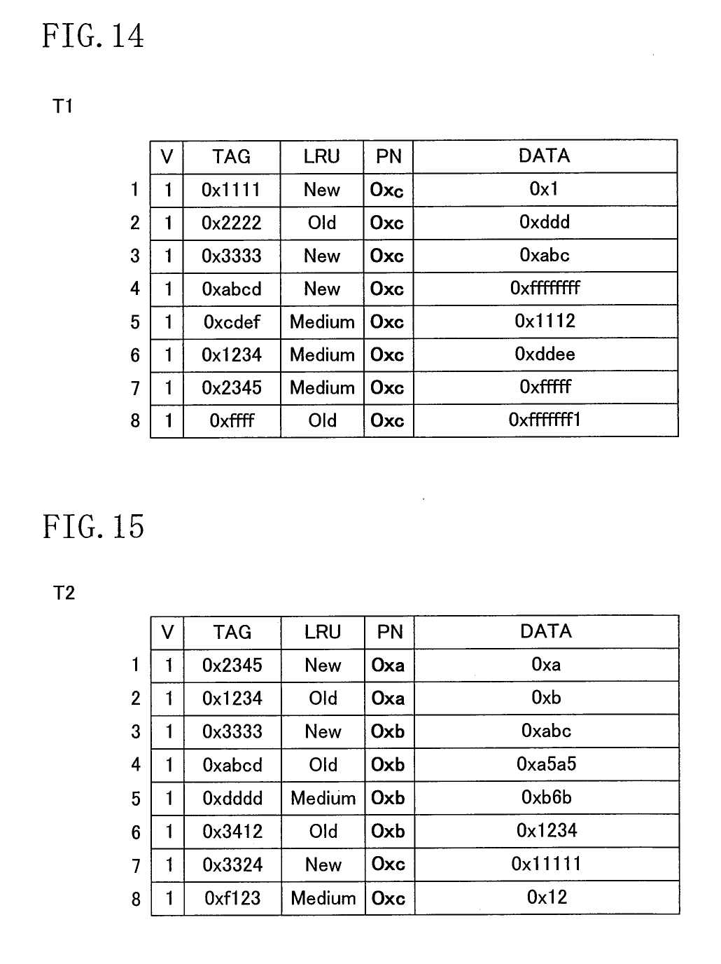

FIGS. 14, 15 and 16 show the internal state of the cache memory 13 of FIG. 12 at Time T1, Time T2 and Time T3 in FIG. 4, respectively. It is herein assumed that the first process unit 11a, the second process unit 11b and the third process unit 11c are represented by the numbers “0xa”, “0xb” and “0xc”, respectively, and that the third process unit 11c is the basic process unit. Therefore, “0xc” is set in the process unit specifying register 22.

Referring to FIG. 14, “0xc” is set as the process unit number (PN) for all cache memory lines after the third process unit 11c runs for a certain amount of time. If, for example, a replacement of a cache memory line occurs in response to a request from the third process unit 11c in this state, Lines 2 and 8 are selected as first candidates to be replaced based on the order of priority shown in FIG. 13. One of these candidates is selected and replaced by the memory replacement controller 15 (the method of selection among candidates with the same level of priority depends on how the system is implemented in practice, and will not be discussed herein as it is not directly related to the present invention). In this operation, “0xc”, being the number of the third process unit 11c, is set as the process unit number (PN) of the subject cache memory line.

Referring to FIG. 15, “0xc” is set as the process unit number (PN) for Lines 7 and 8, which are allocated only to the third process unit 11c, after the first, second and third process units 11a, 11b and 11c run for a certain amount of time. Lines 1 and 2 are storing data of the first process unit 11a, and the process unit number (PN) thereof is “0xa”. Similarly, Lines 3 to 6 are storing data of the second process unit 11b, and the process unit number (PN) thereof is “0xb”. If, for example, a replacement of a cache memory line occurs in response to a request from the third process unit 11c in this state, Line 8 is selected as a first candidate to be replaced based on the order of priority shown in FIG. 13. Then, Line 8 is replaced by the memory replacement controller 15. In this operation, “0xc”, being the number of the third process unit 11c, is set as the process unit number (PN) of Line 8.

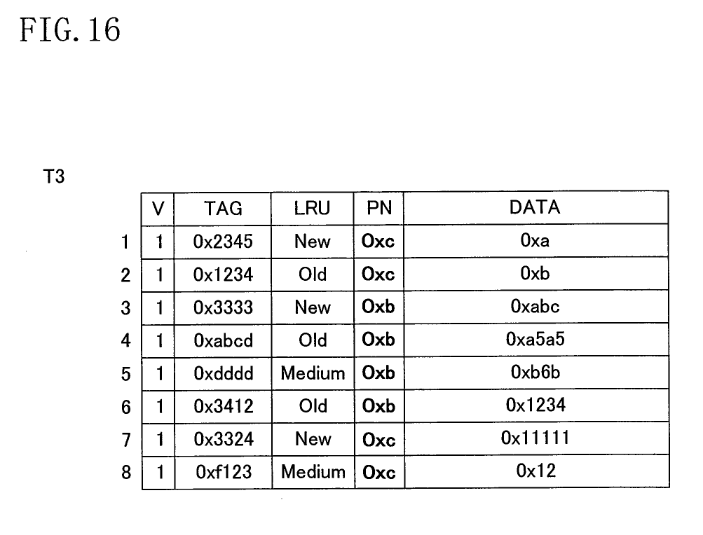

Referring to FIG. 16, “0xc” is set as the process unit number (PN) for Lines 1 and 2 by the release function 21 of the memory controller 14, in response to the termination of the first process unit 11a. The release function 21 is herein realized by a method in which the same number as “0xc”, which is specified in the process unit specifying register 22, is assigned as the process unit number (PN) for all of the cache memory lines allocated to the first process unit 11a. As a result, Lines 1 and 2, which have been allocated to the first process unit 11a, become available to another process unit (the third process unit 11c in the illustrated example). If, for example, a replacement of a cache memory line occurs in response to a request from the third process unit 11c in this state, Line 2 is selected as a first candidate to be replaced based on the order of priority shown in FIG. 13. Then, Line 2 is replaced by the memory replacement controller 15. In this operation, “0xc”, being the number of the third process unit 11c, is set as the process unit number (PN) of Line 2.

As described above, also when the configuration of FIG. 12 is employed for the cache memory 13, it is possible to realize an operation similar to that when the configuration of FIG. 2 is employed. With the configuration of FIG. 12, changes to the process unit specifying register 22 are more quickly reflected in the operation of the computer system 10.

It is understood that the present invention is not limited to the particular embodiments set forth above, and various changes and modifications can be made thereto, all of which shall fall within the scope of the present invention. For example, the cache memory 13 may be divided into portions each being a bundle of cache memory lines, with either the configuration of FIG. 2 or that of FIG. 12.

As described above, with the computer system of the present invention, even when a process unit joins or leaves the group of process units running at the same time, it is not necessary to re-set the amount of allocated cache memory for all process units, and it is also not necessary to provide means for calculating the amounts to be re-set, whereby it is possible to change the amounts of allocated cache memory without complicating the system or creating interference between process units. Thus, the present invention is useful as a computer system, a portable telephone or a similar multi-media set device, etc., using the computer system.

What is claimed is:

1. A computer system, comprising:
a plurality of process units;
a main memory for storing data to be used by the plurality of process units;
a cache memory that can be accessed at a higher speed than the main memory;
a memory controller for allocating divided portions of a storage area of the cache memory to the plurality of process units, wherein when one of the plurality of process units terminates, the memory controller releases a portion of the entire storage area of the cache memory, which has been used by the terminating process unit, so that the released portion is available to another process unit; and
a memory replacement controller storing information on an order of priority between the plurality of process units for controlling replacement of data between the main memory and the cache memory based on a cache memory replacement algorithm taking the priority information into consideration, wherein:
the plurality of process units include a basic process unit for realizing a basic function of a device which uses the computer system; and
the memory controller determines allocation of the cache memory in advance so that a portion of the storage area of the cache memory is dedicated to the basic process unit and at least another portion of the storage area of the cache memory is used preferentially by process units other than the basic process unit over the basic process unit.

2. The computer system of claim 1, wherein the memory replacement controller includes a process unit specifying register for specifying the basic process unit.

3. The computer system of claim 1, wherein when data is transferred from the main memory to a storage area of the cache memory in response to a request from the basic process unit, the memory replacement controller sets a weak flag of the storage area, meaning that the storage area is likely to be replaced, and thereafter uses a cache memory replacement algorithm by which a storage area of which the weak flag is set is preferentially selected.

4. The computer system of claim 1, wherein when data is transferred from the main memory to a storage area of the cache memory in response to a request from one of the plurality of process units, the memory replacement controller assigns the storage area a number that identifies the requesting process unit, and thereafter uses a cache memory replacement algorithm by which a storage area that is assigned a number coinciding with a number of the basic process unit is preferentially selected.

5. The computer system of claim 1, wherein when releasing a storage area of the cache memory so that the storage area is available to another process unit, the memory controller writes data of the storage area back to the main memory and invalidates a validity bit of the storage area.

6. The computer system of claim 5, wherein the memory controller releases a storage area of the cache memory so that the storage area is available to another process unit, within a memory space that has been used by the terminating process unit.

7. The computer system of claim 3, wherein when releasing a storage area of the cache memory so that storage area is available to the basic process unit, the memory controller sets the weak flag for the storage area.

8. The computer system of claim 7, wherein the memory controller releases a storage area of the cache memory so that the storage area is available to the basic process unit, within a memory space that has been used by the terminating process unit.

9. The computer system of claim 1, wherein the basic process unit is a process unit responsible for realizing a call function of a portable telephone.

10. The computer system of claim 1, wherein the basic process unit is a process unit responsible for realizing a music player function of a portable telephone.

11. A method for controlling a computer system, including a plurality of process units, a main memory for storing data to be used by the plurality of process units, and a cache memory that can be accessed at a higher speed than the main memory, wherein the plurality of process units include a basic process unit for realizing a basic function of a device which uses the computer system, the method comprising the steps of:
allocating divided portions of a storage area of the cache memory to the plurality of process units in advance so that a portion of the storage area of the cache memory is dedicated to the basic process unit and at least another portion of the storage area of the cache memory is used preferentially by process units other than the basic process unit over the basic process unit;
replacing data between the main memory and the cache memory based on a cache memory replacement algorithm taking priority information into consideration, the priority information being information on an order of priority between the plurality of process units; and
when one of the plurality of process units terminates, releasing a portion of the entire storage area of the cache memory, which has been used by the terminating process unit, so that the released portion is available to another process unit.
